(19) United States
(12) Patent Application Publication
(10) Pub. No.: US 2025/0069835 A1
(43) Pub. Date: Feb. 27, 2025

(54) A relay with magnetic field generation through a PCB

(71) Applicant: Microtest S.p.A., Vicopisano (IT)

(72) Inventor: Giuseppe Amelio, Lucca (IT)

(21) Appl. No.: 18/842,514

(22) PCT Filed: Mar. 8, 2023
(86) PCT No.: PCT/IB2023/052186

§ 371 Date: Aug. 29, 2024

(30) Foreign Application Priority Data
Mar. 18, 2022 (IT) 102022000005345

(51) Int. Cl. H01H 50/18; H01H 50/04

(52) U.S. Cl. CPC H01H 50/18; H01H 50/043

(57) ABSTRACT

A relay system includes a magnetic field generator, and a first and a second plane, which overlap each other at a predetermined distance, and of which one is movable towards and away from the other plane along a guide. A seat is interposed between the two planes, which can receive a probe of an electrically conductive material and which has a first aperture facing one plane and a second aperture facing the other plane. The probe ends protrude at least partially through the aperture so that each end can come into contact with the plane facing the aperture. The magnetic field generator is configured to generate a first magnetic field that determines a first magnetic force, which causes a motion along the guide and the approach of ne plane towards the other, bringing the two planes into electrical contact through a contact of each plane with the interposed probe.

### SCOPE OF THE INVENTION

The present invention relates to the technical field of relay devices.

In particular, the invention relates to an innovative relay without the traditional winding which controls its activation, thereby resulting in a particularly miniaturized element.

### BRIEF OUTLINE OF KNOWN ART

Relays have been known and in use for a long time.

A relay is an electromechanical component of wide uses and purposes.

It is like an electrical switch through which one has the possibility to manage the flow of electrons and to send the current to different possible directions inside an electrical circuit to which the switch is connected.

Therefore, a relay can be compared to a switch and the difference is in that it is controlled automatically through a suitable circuit instead of being activated manually.

FIG. 1 shows a relay according to known art.

The relay 100 is made up by a support frame T (generally a L-shaped bracket) on which the components described below are positioned or it supports them.

In particular, a reel 101 of copper thread is provided being the end of terminals B-B. The reel is wound around a core of ferromagnetic material supported by the frame T (not visible in figure).

The relay provides a series of electrical contacts S-C-D which are activatable through a suitable bracket ST. When current passes through the reel, its core becomes magnetized and attracts the bracket ST to itself.

In fact, the bracket is hinged on a point R with respect to the frame T and can rotate with respect to it thanks to this hinging both clockwise and counter-clockwise.

More specifically, FIG. 1 shows with numbers 102′ and 102″ the two metallic portions positioned at a certain distance from each other and of which the 102′ belonging to the bracket and the other 102″ belonging to the part where the reel is wound.

As mentioned, the bracket is hinged on a point R thereby it can rotate with respect to this point.

In this way, after a counter-clockwise rotation, the portion 102′ can be brought to abut against the portion 102″.

The bracket is made by a first horizontal section 103a, by a vertical section 103b and by a further horizontal section 103C, parallel to said previous one 103a, which controls the movements of the contacts (S-C-D). The vertical section 103b is connected to the two horizontal sections (103a, 103c).

A horizontal rod 104 exiting from the frame T stretches horizontally in a way parallel to the section 103c and supports the vertical rods (i.e. the lamellae 21, 22 and 23) having the contacts (S-C-D) at their ends. The lamellae 21, 22 and 23 are fixed to said rod 104.

Also the lamella 22, having the contact C, is fixed to the rod 104 but it is further fixed to the end of the horizontal end section of the rod 103c.

In this way, if current is injected into the winding through the contacts B-B, this causes the current to pass into the winding. The core becomes magnetized and therefore a magnetic field is generated which brings the portions 102′ and 102″ to attract themselves with consequent rotation of the bracket around the point R. If the magnetic field is released, the attraction ends and the bracket counter-rotates.

As shown in FIG. 1, the rotation of the bracket counter-clockwise is due to the attraction between the parts 102′ and 102″ and this rotation causes the portion of bracket 103c to push onto the lamella 22 which bends around its fixing point with the rod 104 and bringing the two contacts C and D to touch each other.

Therefore, once the magnetic field has been activated, the lamella 22 which initially was in contact with the lamella 21 through their contacts S-C, comes consequently into contact with the lamella 23 (contacts C-D). Once the magnetic field has been released, the bracket ST counter-rotates and this causes a counter-bending of the lamella 22 (as mentioned, due to the counter-rotation of the hinged bracket) thereby restoring the initial condition.

Therefore, with this method, a switchover is achieved: the central contact C is switched over from S to D or vice versa.

Anyway, this solution of known art has some technical drawbacks.

In particular, these solutions can be little “miniaturized”.

Moreover, due to the high number of switchovers to be performed, the solutions of known art are easily subject to faults.

Consider, by way of example, that a relay on the market can perform from 106 to 108 switchovers before breaking, with durations that, however, are less than one year, according to modern applications and needs.

### SUMMARY OF THE INVENTION

Therefore, the aim of the present invention is to provide an innovative relay which resolves said technical disadvantages.

In particular, the aim of the present invention is to provide an innovative relay which is reliable and that is capable of performing a high number of switchover cycles without running into faults.

In particular, a further aim of the present invention is to provide a relay which is long-lasting and further structured in such a way as to enable a miniaturization thereof.

These and other aims are therefore achieved with the present relay, according to claim 1.

This relay system comprises:
An actuator (3), preferably linear, comprising a channel forming a sliding guide into which a movable element (6) is slidingly mounted;
A first (1) and a second plane (2) overlapping each other at a predetermined distance;
One of said two planes (1) is integrally connected with the movable element (6), which movable element (6) is slidingly mounted into said sliding guide (for example the movable element 6 can be part and be the sliding component of the actuator itself).
Therefore, the actuator can be activated for moving along said sliding guide said movable element (6) in such a way that said plane is movable through the movement of said movable element (6) thus enabling it to move towards/away from the other plane;
The movement of the movable element occurs between a position extracted at least partially from the sliding guide and a position retracted at least partially into the sliding guide.
And wherein said relay system comprises at least one seat (SE1, SE2) into which at least one probe (S1, S2) of electrically conductive material is/can be arranged, said seat being interposed between said first and second plane;
Said seat has at least one first aperture facing a plane and at least one second aperture facing the other plane and through which the two probe ends protrude at least partially in order to be able to bring into contact each one respectively with a corresponding plane towards which the aperture is facing.

In this way, all the above-mentioned technical disadvantages are solved.

Therefore, the idea at the basis of the project is to eliminate the reel and the ferromagnetic material around which it is wound up.

This is obtained with the configuration claimed through the use of an actuator, for example magnetic or electromagnetic and preferably of the linear type.

There are many types of these actuators on the market that can be used for the purposes.

The actuator activates the linear movement of a plane which approaches the other, passing to a “ON” condition through the contact with the interposed probe.

In this way, the following advantages are obtained:
Remarkable reduction of the sizes of the device and miniaturization accordingly;
Making the “switch” between the “on” and the “off” position immediate. Now the magnetic field that activates the device is generated by two overlapping layers which will bring the device into an On/Off state without generating the generation of the “spike” at the switch-on which is generally visible on the oscilloscope during the activation of a relay of the “traditional” type.
Increase of the average lifespan of the device. In “traditional” relays, the current that flows in the contact is very small but it causes with time the formation of oxide on the surface of contacts, which prevents the current from passing.

Advantageously, the pins of the device can be replaced by special connectors made of graphene, whose advantages are wear reduction over time and size reduction.

Advantageously, said actuator is configured to generate at least one first magnetic field and the movable element 6 (also called “body (6)” in the present description) is an element sensitive to said magnetic field.

In this way, advantageously, when said first magnetic field has been generated, a first magnetic force is generated which causes a motion along said guide of said movable element (6) with a consequent approach of the movable plane towards the other plane bringing electrical contact said two planes to each other through a contact of each one of said two planes with said interposed probe.

Advantageously, the actuator is further configured to generate a second magnetic field which generates a second magnetic field which generates a second force opposite to said first force in such a way as to determine a moving-away motion along said guide of at least one movable plane towards the other plane in such a way as to cause a separation of at least one probe end from the relative plane with which it is in contact.

Substantially, the movable element of the actuator moves in the direction opposite to the previous one.

In this way, the relay can be fully controlled by a linear motion of the magnetic actuator through the generation of suitable magnetic fields passing from the ON and OFF condition.

Advantageously, said two planes are electrically conductive.

Therefore, when the relay is in a contact configuration (“ON”), the signal passes through the two planes by means of the interposed probe which is in contact through its two ends with said two planes.

Advantageously, for example both these planes are in the form of a PCB.

Advantageously, in all the configurations, a plane is fixed and the other is sliding along said guide.

In this case there is a fixed plane (plane 2) and a movable plane (plane 1).

Advantageously, the actuator can be an actuator of the magnetic or electromagnetic type, preferably linear.

Many types of them are on the market.

Advantageously, the movable element (6) is part of the actuator itself and therefore the element is activated (generally with a simple shifting) through the magnetic field generated by the actuator itself (magnetic or electromagnetic actuator).

Advantageously, the body (6) (or movable element in other words) can be a magnet, preferably of cylindrical shape, and sliding into the guide which is obtained directly in the body of the actuator itself (for example the body 6 is part of the actuator, in particular the linearly movable component).

Advantageously, the second plane (2) is fixed and a probe end is in contact with said second plane in such a way that the opposite end is directed at the first plane which is movable, said first plane being integral with the movable element (6).

Advantageously, a housing (9, 10) can be provided which can be opened into at least two halves to enable the access to the seat of the probes, the probes being interchangeable.

In an advantageous solution, the probes could be for example the ones described in the patent application 102020000013978 of Nov. 6, 2020 entitled “A probe-holder support and relative probes with facilitated mounting” in the name of the same Applicant.

Therefore, said application No. 102020000013978 is to be considered to be fully incorporated into the present text by reference.

Advantageously, the guide bottom is delimited by the second plate (2) and wherein, when the probe is separated by the first plate, a space (4) is formed between the second plate (2) and the base of the body (6).

Advantageously, the body can be a magnet or a ferrous element.

A method of ON/OFF activation of a relay is also described here, the method comprising the arrangement of a relay system according to one or more of the features mentioned above and the activation of the actuator in a direction in such a way as to bring the two planes (1, 2) into a condition of electrical contact with each other through the interposed probe/s thereby bringing the relay system into an ON condition.

Obviously, then the actuator (for example the linear actuator of the magnetic or electromagnetic type) can be activated in the opposite direction to move said plane away from each other bringing the relay system into an OFF condition.

### BRIEF DESCRIPTION OF THE DRAWINGS

Additional features and advantages, according to the invention, will become apparent from the following description of some of the preferred embodiments thereof, given only by way of non-exhaustive example, with reference to the attached drawings, wherein:

FIG. 1 shows a relay according to the known art;

FIG. 2 and FIG. 3 schematize a “probe card” system and relative PCB;

FIG. 4 schematizes a relay solution according to the invention in a condition in which the plate 1 is spaced from the interposed probes and with the plate which is moved linearly through an actuator, preferably of the linear magnetic or electromagnetic type;

FIG. 5 shows the same schematization but with the probes in contact with the plate 1 and therefore with the bent probes and the two plates 1 and 2 in electrical contact with each other through the probes.

### DESCRIPTION OF SOME PREFERRED EMBODIMENTS

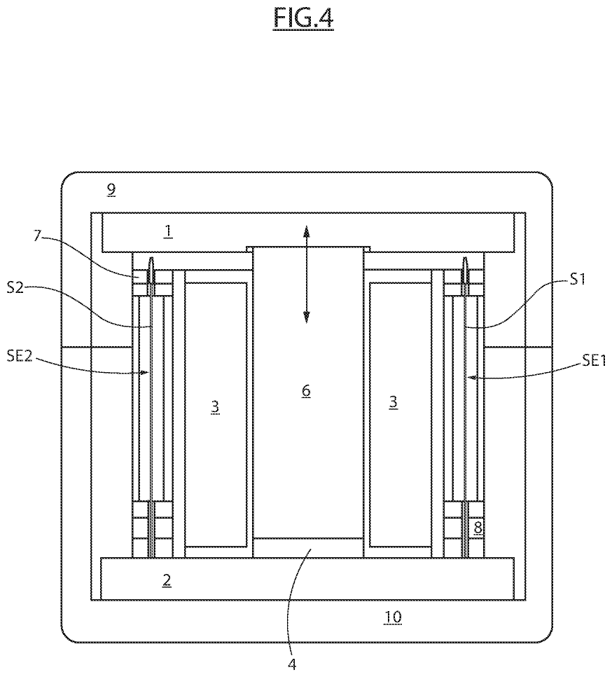

FIG. 4 shows a structural solution according to the invention.

The relay subject-matter of the invention provides two overlapping plates indicated with numbers 1 and 2 which are part of a PCB system or both plates themselves are in the form of a PCB board.

In particular, the two plates can be respectively the upper plate 1 and lower plate 2 of a PCB.

The PCB is an acronym for “printed circuit board”. In electronics it is a support used to interconnect various electronic components of a circuit to each other through conductive tracks carved onto a non-conductive material. Usually, the material used as support is copper-coated fiberglass, namely a plate of fiberglass covered with a thin metallic layer. This layer is subsequently carved with the technique of photoengraving (through the action of light and acids) or with the technique of mechanical milling (through CNC milling machine). The carving is necessary to create the above-mentioned tracks which interconnect the various components of the projected circuit to each other.

For example, the PCB can be generally part of a “probe card”.

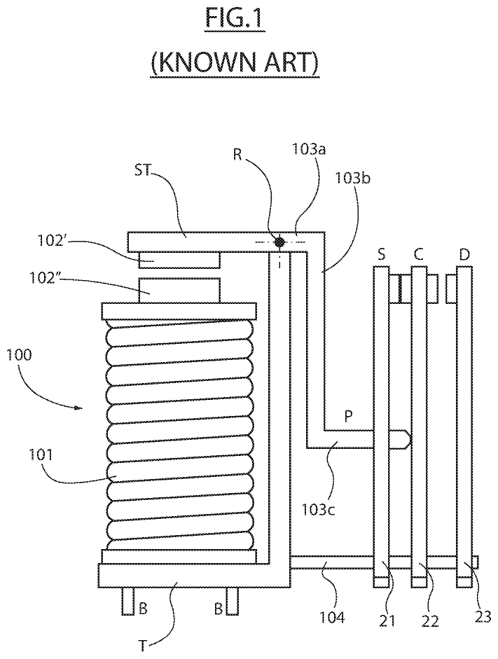

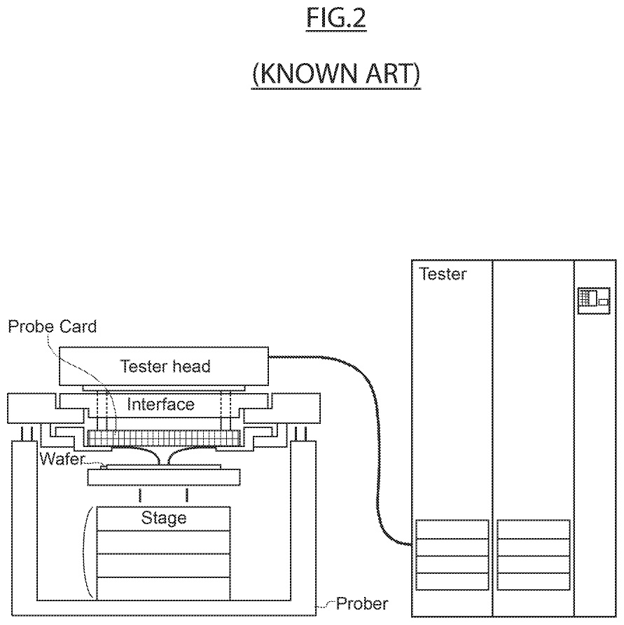

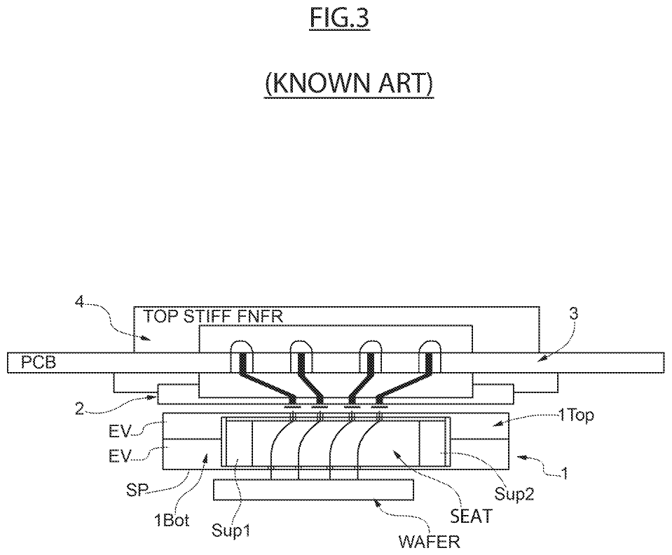

More specifically, as per known art depicted in FIGS. 2 and 3, it is highlighted that the “probe card” is an interface between the test system and wafer. This interface is used during the test of electronic devices. It has the task of electrically connecting the circuits of the device (in the wafer) and the resources of the tester (see FIG. 1 “known art”).

As schematized in FIG. 2, still known art, a “probe card” is in turn usually formed by:
Said “PCB” 3 (acronym for “printed circuit board”), therefore a printed electrical circuit board;
A frame 4 to enable planarity and;
A probe-head 1 which is the structure inside which the probes are positioned.

The probe-head 1 is made up by a structure which keeps the probes into position and by the probes themselves.

In the event of vertical probes, it (the probe head) typically comprises two holed plates, generally made of ceramic, which act as a guide and in which the probes are inserted. These ceramic plates are in the form of an upper ceramic plate and a lower ceramic plate which are generally named “Guide Plates” in technical jargon and they are indicated in FIG. 3 with numbers (1Top) and (1Bot) (namely upper and lower).

When they have been coupled, they form the inner seat inside which the probes are housed with the ends of the probes exiting from said ceramic plates through holes in such a way that they are in contact on one side with the wafer and on the opposite side with the electrical communication towards the PCB (see FIG. 2).

These upper and lower ceramic plates have at their ends a vertical extension (EV) as a column which branches off vertically from the flat surface (SP).

In this way, as it can be inferred well from FIG. 3, the upper and lower plate are in direct contact with each other through these vertical extensions (EV) which therefore represent a contact edge of the two plates and with respect to which the flat surface of the plate (SP) is raised thereby forming the seat for the probes.

Furthermore, the coupling between the upper plate (1Top) and the lower one (1Bot) can possibly be aided by two further supports (Sup1, Sup2) placed as a load-bearing column at the two ends of the seat, delimiting the seat itself on the right and on the left.

The further supports can be only one of annular shape if the whole probe head is circular, for example (depending on the shapes).

Even if it is structurally complicated, this structure enables the correct mechanical functioning of the probes that deform inside the probe head during the contact with the wafer, enabling to manage the dimensional and shape tolerances of the parts and to keep the contact force under control.

Therefore, during the test, the electrical signals are sent from the machine and through the PCB they are transmitted to the wafer by means of interposed probes.

The probes are inserted into the support forming part of the probe head, and they must have electrical and mechanical properties.

Electrical properties because they have the task of contacting pads in the wafer with the contacts of the PCB of the probe card. Mechanical properties because they must guarantee the electrical contact for numerous test cycles, bearing the continuous deformations without damaging the wafer, thereby enabling to manage the dimensional and shape tolerances of the parts and to keep the contact force under control.

In view of the above, the structure of the relay subject-matter of the invention reproduces in part the structure indicated above of the probe head of FIG. 3.

In particular, FIG. 4 shows the solution in which two plates 1 and 2 (or planes in other words) arranged parallelly to each other are evident.

Their arrangement is such as to be parallel to the ground when the whole system (or assembly in other words) shown in FIG. 4 leans with its base 10 on the horizontal ground.

In particular, in the preferred solution of the invention, at least one of the two plates is movable with respect to the other, that is one is fixed and the other is movable.

Preferably, the plate 1 is movable with respect to the plate 2, that is it can move towards/away from the plate 2 according to a vertical motion (i.e. it moves according to a direction orthogonal to the surface of the plate 2—see the double arrow direction in figure).

As shown in FIG. 4, the component 6 is an element sensitive to the magnetic field which is integral with the plate 1.

For example, it can be with cylindrical shape like a cylindrical rod. For example, it can be made of ferrous material or magnetic material (for example it can be a magnet).

As better specified below, it is the movable linear element of a preferably magnetic or electromagnetic actuator.

Still as shown in FIG. 4, number 4 indicates the play (or empty space in other words) between the lower end of the component 6 and the surface of the plate 2 facing this component 6 (in particular the base of the actuator itself).

The component 6 slides along a guide which, as mentioned above, is obtained as a channel directly obtained in an actuator 3.

The actuator channel surrounds the component 6 (i.e. the body sensitive to the magnetic field) that is slidingly positioned in said channel forming the guide.

Substantially, the actuator can comprise the same body 6 (in other words the body 6 is part of the actuator).

Many actuators are on the market and they are constituted by a guide channel and with the body 6 (generally in the form of a rod) which slides inside the channel. The body can be in the form of a rod and represents the element linearly movable between an extracted position, at least partially positioned outside the channel, and a position retracted inside the channel.

This movement is controlled by the linear electromagnetic or magnetic actuator through suitable generation of the magnetic field.

Many actuators of this type are on the market which enable to precisely check the various positions of the rod, the speeds etc., the shifting force etc.

The person skilled in the art will be able to select one of these possibilities.

The space 4 depicted in FIG. 4 is the residual space of this channel occupied by the body 6 relative to the actuator.

Substantially, the body 6 can slide until it touches the plate 2 or anyway approaching it thereby nullifying or reducing the space 4 and therefore integrally dragging the plate 1 with which it is connected in an integral way.

Therefore, the body 6, preferably cylindrical, moves into a preferably cylindrical channel obtained or being part of the actuator 3.

The actuator is preferably of magnetic or electromagnetic type thereby moving the body (6) (for example a rod, as mentioned) through the generation of a suitable magnetic field.

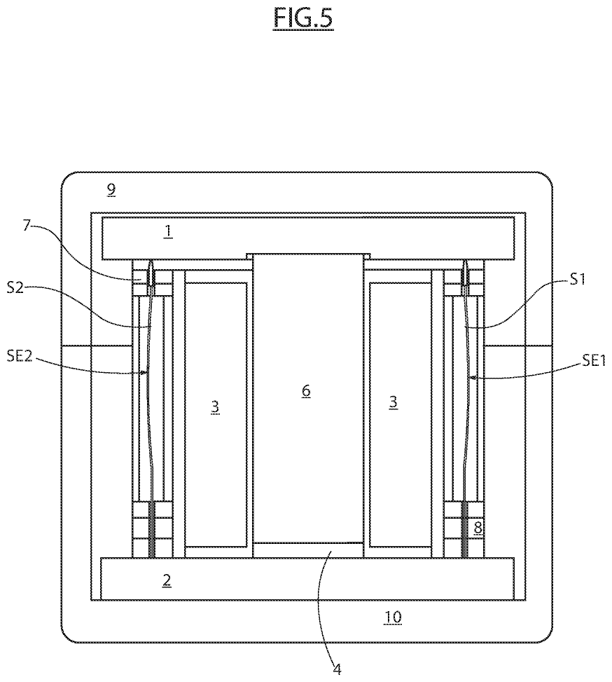

The body 6 moves between a position extracted from the guide channel of the actuator (see FIG. 4) to a position at least partially retracted into the channel (see FIG. 5) and vice versa.

Substantially, as per the double arrow direction of FIG. 4, the plate 1 moves sliding through the guide (see the double arrow direction).

The component 3 which surrounds the body 6 sensitive to the magnetic field is as mentioned an actuator suitable for generating a magnetic field and the body 6 is the linear element of the actuator which is moved (for example, in the form of a cylindrical rod).

The actuator can be of outer cylindrical, square, rectangular, etc. shape (other outer shapes could be possible and are available on the market) with its inner channel which develops along its longitudinal axis, which forms a guide for the body 6.

The actuator can be selected of necessary size and power.

The generation of the magnetic field is such as to generate a magnetic field acting onto the body 6 such as to determine a force towards the plate 2 and therefore a force that tends to make the body 6 slide along the plate 2 thereby nullifying or tending to nullify the space 4.

Therefore, in this condition, the plate 1 (integral with the column 6) tends to move towards the plate 2.

Substantially, the magnetic field which is generated determines a first force which makes the rod 6 slide in the direction from the plate 1 towards the plate 2, thereby nullifying the play 4 and thus approaching the plate 1 to the plate 2 (in fact, the plate 1 is integral with the rod 6).

Still FIG. 4 shows then that two probes S1 and S2 interposed between said two plates (1, 2) are provided which are inserted into suitable seat (SE1, SE2), respectively.

The probes are of electrically conductive material, such as graphene, in such a way as to be able to conduct electrically.

The probes are substantially the ones described in known art of FIGS. 2 and 3 and can have various different shapes.

Any type and shape of probe can be used.

As mentioned, the probes are of conductive material and besides they are flexible, that is also according to the uses of known art already described in the preamble of FIGS. 2 and 3 they have a certain degree of flexibility when they are normally compressed and then go back to the non-bent state.

As per FIG. 4, the probes are arranged standing in the corresponding seats (SE1, SE2) in such a way as to be protruding vertically from the lower plate 2 with which they are in contact with an end thereof to touch with their tip (opposite end) the plate 1, exactly as already described in known art regarding the probe heads described above, when the plate 1 approaches the plate 2.

More specifically, as still shown in FIG. 4, there is an initial spaced position of the plate 1 from the ends of the probes whereas the probes, with the opposite end, leans in contact on the plate 2.

When the magnetic field which determines a certain force on the column (or rod in other words) 6 is generated such that the column slides along its guide obtained in the body of the same actuator of magnetic field and the plate 1 approaches the plate 2 bringing itself into contact with the points of the probes, as shown in FIG. 4.

In this way the two plates 1 and 2 are in electrical contact with each other through the probes.

By changing the magnetic field, that is generating a magnetic field opposite to the previous one (therefore controlling the actuator to a movement opposite to the previous one) still through the actuator 3, the plate 1 tends to move away from the plate 2 thereby determining the fact that the tip of the probe is not in contact with the plate 1, as per FIG. 5.

As well known, the actuators on the market are able to control the extraction/retraction motion.

Therefore, when a first magnetic field is activated through the actuator, this acts on the body 6 (for example a magnet 6) thereby generating a force which makes the body 6 slide and integrally the plate 1 towards the plate 2 until it brings the plate 1 in contact with the tip of the probes (FIG. 5).

This configuration is kept for all the time in which the magnetic field is kept active.

By generating a magnetic field opposite to the previous one, an opposite force is generated still acting on the column 6 which tends to make the columns slide in the opposite direction thereby moving the plate 1 away from the plate 2 as per FIG. 4.

According to this preferred and particularly advantageous solution, there is no spring or mechanical system to bring the plate 1 to the spaced position given that one acts only and exclusively through the generation of suitable magnetic fields through the actuator (or generator in other words) of magnetic field 3.

However, in an alternative, one can provide a solution in which a spring is comprised, for example arranged in the space 4 between the body 6 and the plate 2.

In this case, when the spring is compressed because of the approaching motion of the plate 1 to the plate 2, this tends to move the plate 1 away from the plate 2 upon the release of the magnetic field bringing the plate 1 to the position of FIG. 4 spaced from the ends of the probe/s.

According to this solution, a one-directional actuator should be used with the opposite motion which does not occur by generating the magnetic field opposite to the previous one but by means of elastic force that restores the condition of FIG. 4.

However, this solution requires the presence of an additional component, namely the spring, and therefore it is more complex.

Provided what has been described above, the whole can be closed by a housing (9, 10) made by two detachable parts.

According to the invention, the two plates 1 and 2 are part of a PCB.

For example, both are indeed a lower PCB and an upper PCB.

Therefore, the plate 1 is defined here an upper PCB and the plate 2 is defined here a lower PCB.

PCBs are specific circuits and therefore an incoming signal for example through the PCB 2 can be transmitted to the PCB 1 when this is brought into contact with the interposed probes.

Therefore, when the actuator is activated to generate the magnetic field, the latter brings the plate 1 into contact with the plate 2 (see FIG. 5) and with said two plates which are in the form of a printed circuit board or simply printed circuit (called PCB). In this way, there is an ON condition in which the signal passes from a board to the other (i.e. closed relay). Otherwise, an OFF condition would occur when they are spaced (see FIG. 4—i.e. open relay).

As indicated in FIG. 4 and FIG. 5, the system can be opened into two halves. In fact, the part 9 is provided separable from the part 10.

This enables an access inside which enables to insert and/or remove any probe, therefore being able to replace them with different probes depending on needs.

As mentioned, any type of probe can be used, for example the ones already described in the publication WO2021250598 or 102020000013978, both in the name of the same Applicant and with said international and/or description fully incorporated here by reference (therefore it must be considered included into the present description).

The invention claimed is:

1. A relay system comprising:
an actuator (3) comprising a sliding guide into which a movable element (6) is slidingly mounted;
a first (1) and a second plane (2) overlapping each other at a predetermined distance, one of said first and second planes (1) having said movable element (6) integral therewith that is slidingly mounted, into the sliding guide, between a position extracted at least partially from the sliding guide and a position retracted at least partially into the sliding guide, said actuator being configured to be activated for moving, along said sliding guide, said movable element (6) in such a way that said first or said second plane is movable through a movement of said movable element (6), thus enabling said first or said second plane to move towards/away from the second or the first plane; and
a seat (SE1, SE2) into which a probe (S1, S2 made from an electrically conductive material can be arranged, said seat being interposed between said first and said second plane, said seat having a first aperture, which faces one of the first or the second planes and a second aperture facing another one of the first or the second planes, and through which two probe ends protrude at least partially in order to be able to bring into contact each of the two probe ends respectively with the one of the first or the second planes facing the aperture.

2. The relay system, according to claim 1, wherein said actuator is configured to generate a first magnetic field, and wherein the movable element (6) is a body sensitive to said first magnetic field such that, when said first magnetic field has been generated, a first magnetic force is generated which causes a motion along said guide of said movable element (6) with a consequent approach of the one of the first or the second plane towards the other one of the first or the second plane, thereby bringing into electrical contact said first and said second plane to each other through a contact of each one of said first and said second planes with said interposed probe.

3. The relay system, according to claim 2, wherein said actuator is further configured to generate a second magnetic field which generates a second force opposite to said first force in such a way as to determine a moving-away motion along said guide of the one of the first or the second planes towards the other one of the first or the second plane in such a way as to cause a separation of at least one probe end from the corresponding plane with which the probe is in contact.

4. The relay system, according to claim 1, wherein both of said first and said second planes are electrically conductive.

5. The relay system, according to claim 1, wherein both of said first and said second planes are configured as a PCB.

6. The relay system, according to claim 1, wherein the one of the first or the second plane is fixed and the of the first or the second plane is sliding along said guide.

7. The relay system, according to claim 1, wherein the actuator is a magnetic or an electromechanical type actuator.

8. The relay system, according to claim 1, wherein the movable element (6) is part of the actuator.

9. The relay system, according to claim 1, wherein the movable element (6) is a magnet, sliding into the sliding guide which is obtained directly in a body of the actuator.

10. The relay system, according to claim 1, wherein the second plane (2) is fixed and a probe end is in contact with said second plane in such a way that an opposite end of the probe is directed at the first plane which is movable, said first plane being integral with the movable element (6).

11. The relay system, according to claim 1, further comprising a housing (9, 10) which can be opened into at least two halves for enabling the access to the seat of the probe, the probe being interchangeable.

12. The relay system according to claim 1, wherein a bottom of the guide is delimited by the second plane (2), and wherein, when the probe is separated from the first plane, a space (4) is formed between the second plate (2) and a base of the movable element (6).

13. An ON/OFF activation method of a relay, the method comprising:
arranging a relay system according to claim 1; and
activating the actuator in a direction in such a way as to bring the first and the second plane (1, 2) into a condition of electrical contact with each other through the probe interposed therebetween, thereby bringing the relay system into an ON condition.
